(19) United States
(12) Patent Application Publication
(10) Pub. No.: US 2025/0065972 A1
(43) Pub. Date: Feb. 27, 2025

(54) Positionable Seat Post Assembly

(71) Applicants: Nicholas Payton, Chico, CA (US); Tyler Reiswig, Chico, CA (US)

(72) Inventors: Nicholas Payton, Chico, CA (US); Tyler Reiswig, Chico, CA (US)

(21) Appl. No.: 18/811,507

(22) Filed: Aug. 21, 2024

Related U.S. Application Data
(60) Provisional application No. 63/533,875, filed on Aug. 21, 2023.

(51) Int. Cl. B62J 1/08; B62J 1/02; B62J 45/00; B62J 45/41; B62J 50/00

(52) U.S. Cl. CPC B62J 1/08; B62J 1/02; B62J 45/00; B62J 45/41; B62J 50/00

(57) ABSTRACT

A positionable seat post assembly for a bicycle is described herein. The positionable seat post assembly includes a four-bar linkage coupled between a seat post of the bicycle and a seat of the bicycle. The four-bar linkage is actuated by a control at a handlebar of the bicycle and includes two or more discrete positions for the seat. The four-bar linkage includes a latch mechanism with detents and a latch element to enable positioning of the seat based on the detent positions. The latch element is actuated by a cable or other linear member actuated in response to a control positioned at a handlebar of the bicycle.

### CROSS-REFERENCE TO RELATED APPLICATIONS

This application claims priority to and benefit of U.S. Provisional Patent Application 63/533,875, filed Aug. 21, 2023 titled “Positionable Seat Post Assembly” the entire contents of which are hereby incorporated by reference for all purposes.

### TECHNICAL FIELD

The present invention generally relates to bicycle seat assemblies, and particularly to positionable bicycle seat post assemblies that enable on the fly position adjustment.

### BACKGROUND

Bicycle design is an exercise in compromise. Frame geometry is often optimized for different terrain. If a bicycle is intended to be used across multiple terrain types a middle ground must be selected that does not sacrifice too much on any extreme, but such a bicycle will never perform as well on a given extreme as one that is more limited in scope.

While riding, moving the seat or saddle forward enables the rider to apply more power to the pedals, improves weight distribution when climbing, and allows for more aggressive aerodynamic positions while pedaling. Moving the saddle back (e.g., towards a rear of the bicycle) improves weight distribution when going down hills, allows more freedom of movement to adjust for obstacles and takes weight off the riders hands, improving comfort. Moving the saddle vertically down increases comfort when coasting, greatly increases freedom of movement to adjust for obstacles and allows for more aggressive aerodynamic positions, primarily when descending.

Bikes intended to be ridden over a variety of terrain, including flats, climbs, and descents, some of which may be rough or technical, would benefit from being able to select multiple saddle positions on the fly. Such positions may include a neutral position similar to a standard position, a forward position in which the saddle is shifted forward, a back position in which the saddle is shifted backward, and a dropped and back position with both a decrease in saddle to bottom bracket distance and rearward horizontal change. Such position changes provide benefits to riders as the rider traverses a variety of terrain and would benefit from being adjustable while traversing the varied terrain.

### BRIEF DESCRIPTION OF THE DRAWINGS

FIG. 1 depicts a bicycle with a positionable seat assembly, according to at least one example.

FIGS. 2A-2C depict a seat assembly configured in different positions, according to at least one example.

FIG. 3 depicts a section view of a positionable seat assembly, according to at least one example.

FIGS. 4A-4B depict a detail view of a portion of a locking mechanism of a positionable seat assembly, according to at least one example.

FIGS. 5A-5D depict a detail view of a series suspension element in a positionable seat assembly, according to at least one example.

FIG. 6 depicts a detail view of a portion of a locking mechanisim of a positionable seat assembly, according to at least one example.

FIG. 7 depicts a locking mechanism of a positionable seat assembly, according to at least one example.

FIG. 8 depicts a locking mechanism of a positionable seat assembly, according to at least one example.

FIG. 9 depicts a locking mechanism of a positionable seat assembly, according to at least one example.

FIG. 10 depicts a locking mechanism of a positionable seat assembly, according to at least one example.

FIG. 11 depicts a locking mechanism of a positionable seat assembly, according to at least one example.

### DETAILED DESCRIPTION

Examples of a positionable seat assembly for a bicycle are described herein. In particular, the systems and components described herein provide an adjustable coupling of a saddle or seat to a bicycle or other pedal driven vehicle via a linkage. In examples, the positionable seat assembly may be referred to as a linkage dropper. The linkage dropper serves a purpose analogous to, but distinct from, that of a linear dropper post in that it facilitates the repositioning of the bicycle saddle along an arced path relative to the frame of the bicycle by the rider while the bicycle is in motion.

In examples, such as may be implemented in a gravel bicycle, road bicycle and/or mountain bicycle the positionable seat assembly or seat support assembly implements a linkage assembly rather than a linear slider as is typically incorporated in dropper seat posts. Such bikes are intended to be ridden over a variety of terrain, including flats, climbs, and descents some of which may be rough or technical would benefit from being able to select multiple saddle positions on the fly. Such positions may include a neutral position similar to a standard position, a forward position in which the saddle is shifted forward, a back position in which the saddle is shifted backward, and a dropped and back position with both a decrease in saddle to bottom bracket distance and rearward horizontal change. Such position changes provide benefits to riders as the rider traverses a variety of terrain and would benefit from being adjustable while traversing the varied terrain.

By using a linkage rather than a linear slider, the system is able to provide significant kinematic improvements. The dropped position is both lower and rearward of the neutral position resulting in much more stability on descents when compared to a typical dropper that shifts a seated riders bodyweight forward. The arced path also enables the seat to be positioned in a forward climbing position that is functionally similar to making the seat tube angle steeper which is beneficial both when climbing and when using aero bars to enable the user to provide additional power through the pedals of the bicycle.

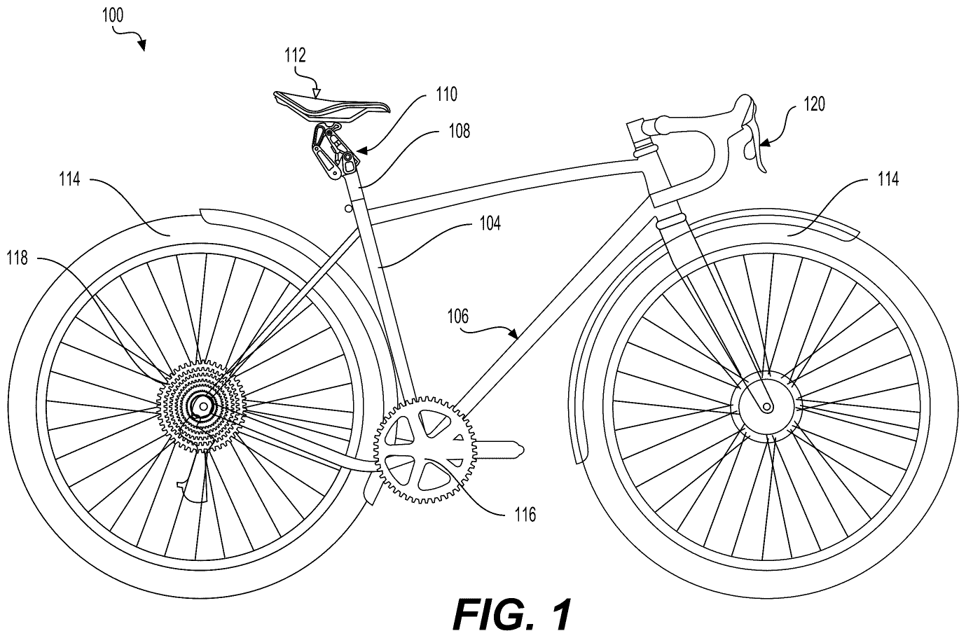

Turning now to the figures, FIG. 1 illustrates a bicycle 100 illustrated with a positionable seat assembly 110, according to at least one example. The bicycle 100 includes a frame 102 that has a seat tube 104, downtube 106, and seat post 108. Though depicted as a road or gravel bicycle, the bicycle 100 may be any suitable bicycle or vehicle that may include a seat 112 for a rider to rest upon. The bicycle further includes wheel assemblies 114, drive components 116 that the rider engaged with at the bottom bracket of the bicycle 100 and a gear assembly 118 to drive the wheel assembly 114 in response to force applied to the drive components 116. The bicycle 100 may be an example of a vehicle as described herein that includes a seat for supporting a rider, with the seat positionable by the rider during riding, without having to stop and dismount and adjust the seat position using tools or quick-clamp assemblies. Rather, the bicycle 100 is equipped with a positionable seat assembly 110 that enables on-the-go positioning of the seat based on the needs and desires of the rider.

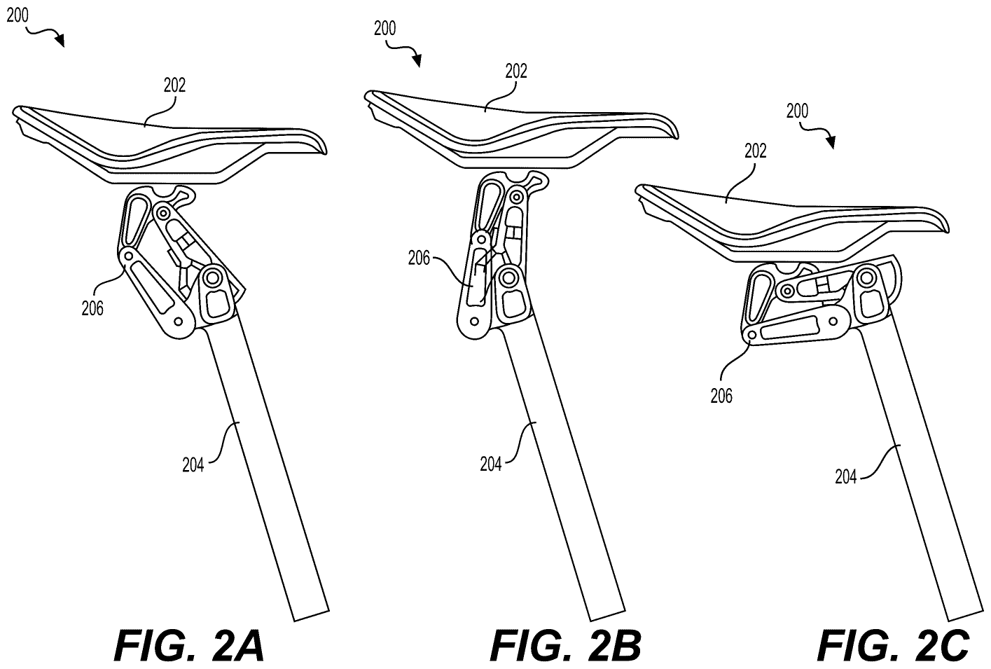

For example, the positionable seat assembly 110 implements a linkage assembly as shown and described herein with respect to FIGS. 2-12. A rider using the positionable seat assembly 110 on a bicycle 100 intended to be ridden over a variety of terrain, including flats, climbs, and descents some of which may be rough or technical would benefit from being able to select multiple seat positions on the fly without having to dismount or stop to adjust the seat position. Such positions may include a neutral position similar to a standard position, a forward position in which the seat 112 is shifted forward, a back position in which the seat 112 is shifted backward, and a dropped and back position with both a decrease in seat 112 to bottom bracket distance and rearward horizontal change. Such position changes provide benefits to riders as the rider traverses a variety of terrain and would benefit from being adjustable while traversing the varied terrain.

FIGS. 2A-2C depict a seat assembly 200 configured in different positions, according to at least one example. The seat assembly 200 is shown having a saddle 202, a post 204, and a dropper assembly 206. In FIG. 2A, the seat assembly 200 is shown in a first position, a neutral position. In the neutral position, the saddle 202 is positioned in line with an axis of the post 204, e.g., in line with a position of the saddle if attached with a standard fixed seat post without the dropper assembly 206. FIG. 2B depicts the seat assembly 200 shown in a forward position, in which the saddle 202 is shifted forward from the position shown in FIG. 2A and a distance from a bottom bracket of the bicycle to the saddle is relatively unchanged, despite the horizontal change in the position of the saddle 202. The change in the horizontal position changes the leg angle of the rider and may enable the rider to provide more power through the pedals of the bicycle, for example during climbs. In examples, a back position (not depicted in FIG. 2), in which the saddle 202 is shifted backwards and the distance from the bottom bracket to the saddle 202 distance change is zero or small relative to the horizontal change may also allow for comfort on flat terrain or better balance on descents FIG. 2C depicts a dropped and back position for the saddle 202 that is the result of a change in the positioning of the dropper assembly 206 and causes a decrease in the distance from the saddle 202 to the bottom bracket of the bicycle and also causes a rearward horizontal change in position that may enable the rider to exercise additional control over rough terrain and a more aggressive aero tuck when descending.

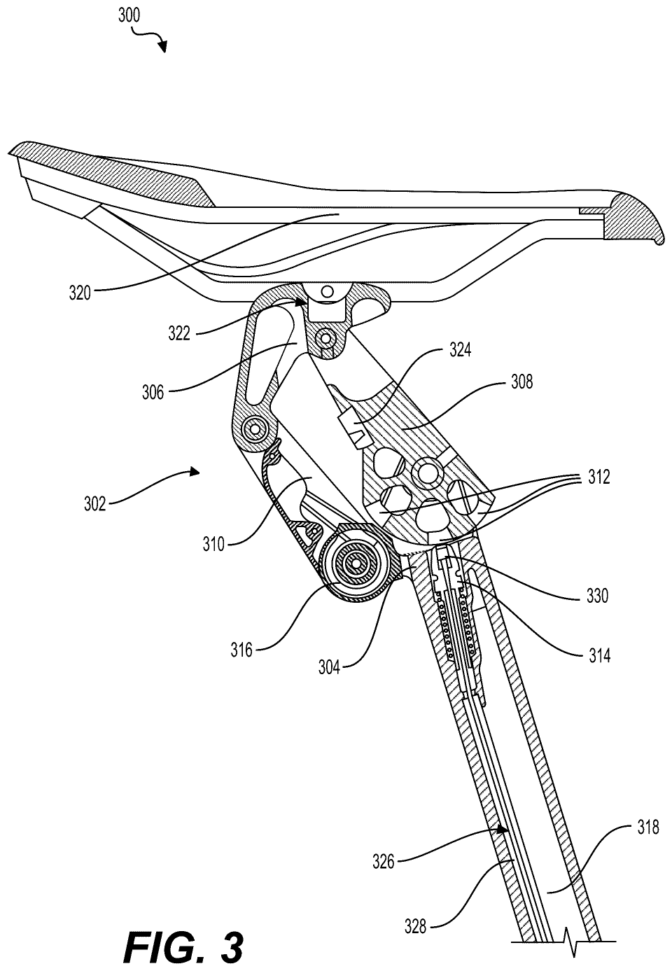

FIG. 3 depicts a section view of a positionable seat assembly 300, according to at least one example. The positionable seat assembly 300 includes three primary links. Referred to herein as the first link 304, second link 308, third link 306. The first link 304 and the third link 306 may each be rotationally coupled to the second link 308 via pivots such that the third link 306 moves in a planar arc relative to the first link 304 as the positionable seat assembly 300 is moved between various positions, such as the positions illustrated with respect to FIGS. 2A-2C. The pivots that form the coupling between the links of the positionable seat assembly 300 may include bearings, bushings, and other such components to enable rotation of the links relative to one another about the pivot locations.

In some examples the positionable seat assembly 300 may include a fourth link 310 rotationally coupled to the first link 304 and the third link 306 such that it forms a four-bar linkage thereby restricting rotation of the third link 306 relative to the first link 304. In some examples a gear, belt, or chain drive may be operably coupled between the first link 304 and third link 306 thereby restricting rotation of the third link 306 relative to the first link 304.

The positionable seat assembly 300 further comprises a lockout mechanism that controllably restricts or induces movement of the links relative to each other. In some examples, the motion of the links, and therefore of the positionable seat assembly 300 may be locked in one or more positions during use via a detent 312 and latch 314 which prevent rotation between two of the links of the four-bar linkage and/or of the first link 304, second link 308, or third link 306. In some examples the detent features may be arranged in an arc operably connected to the second link 308 and the detent latch 314 may be operably connected to the first link 304. The detent latch 314 may have various structures or configurations to lock and/or releasably pivotally lock the positions of the links relative to one another and thereby prevent movement of the positionable seat assembly 300 unless the latch 314 is actuated.

In some examples the detent latch 314 may comprise a single element, which when engaged with one of the detent features 312 restricts movement of one or more of the linkages. In some examples the detent latch 314 may comprise separate elements which when engaged with the detent features 312 may restrict movement in only one direction.

In one example the detent latch 314 may be tapered such that partially disengaging the latch 314 allows a small amount of movement in the second link 308 containing the detent 312 thereby enabling the latch 314 to engage the detent 312 when the detent 312 is slightly out of position and still tightly restrict the movement of the detent 312 when fully engaged.

In some examples the detent features 312 may be placed an equal distance from a pivot of the second link 308. In some examples one or more detents may be placed closer (e.g., radially closer) to the associated pivot and some further (e.g., radially further) from the associated pivot such that the detent latch 314 may be actuated less or more to disengage with detent 312.

In one example the first link 304 is coupled to the frame of the bicycle 100 through the seat tube 104. In one example this coupling is achieved via a seat post 318 and seat tube 104 situated within the frame of the bicycle 100 that facilitates positioning of the first link 304 relative to the frame along the line of the seat tube 104 and which will be fixed while the bicycle is in use. In one example the first link 304 may be integrated directly into the frame.

In some examples the third link 306 may be operably coupled to the seat 320. In some examples this coupling is achieved via a traditional saddle clamp and saddle rail system 322 which facilitates tilt as well as forward and back adjustment of the seat 320 relative to the third link 306 to the extent that the saddle rails 322 allow and which will be fixed while the bicycle is in use.

In some examples the roles of the first link 304 and third link 306 may be reversed, such that the first link 304 is operably coupled to the seat 320 and the third link 306 is operably coupled to the frame (e.g., through the seat post 318). In some examples the second link 308 may be in front of the fourth link 310. In some examples the second link 308 may be behind the fourth link 310.

In some examples the travel of one or more of the linkages and/or distance that the seat 320 moves forward may be constrained in a forward direction by a limit stop. In some examples the travel of one or more of the linkages may be constrained in the rearward direction by a second limit stop. In some examples the limit stops may be cushioned by one or more bumpers 324.

In some examples the first link 304, second link 308, and third link 306 may be sized such that the linkage defines a parallelogram and the angle of the third link 306, and thus the seat 320, stays consistent relative to the first link 304, and thus the vehicle frame, throughout travel of the positionable seat assembly 302. In some examples the links may be sized such that the angle of the third link 306 changes relative to the first link 304 throughout the range of this stroke.

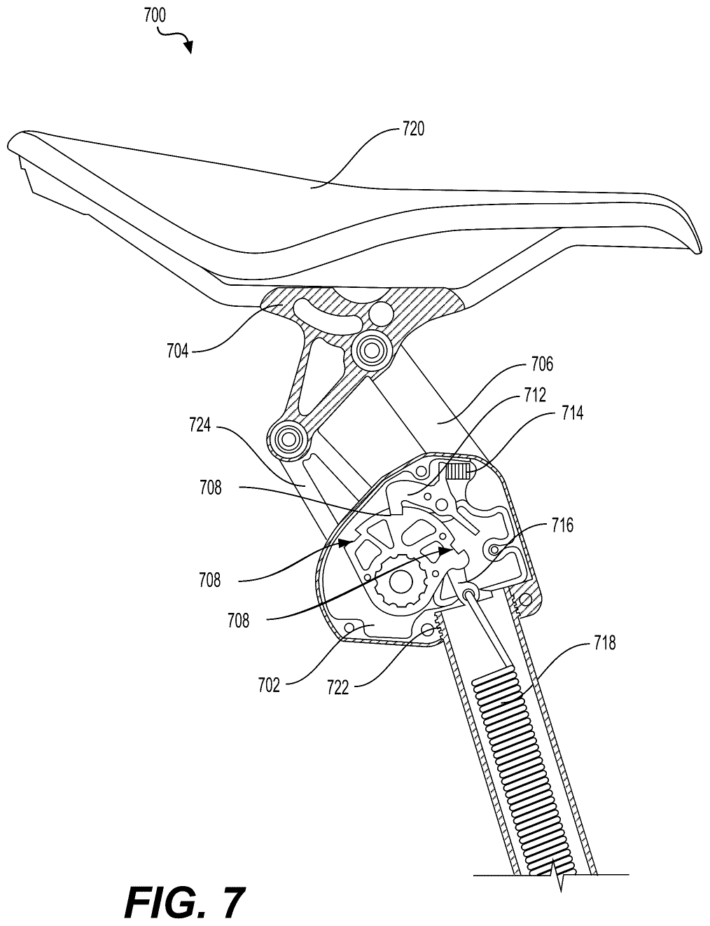

In some examples the linkages of the positionable seat assembly 302 may be sprung such that when the latch 314 is disengaged the positionable seat assembly 302 will move toward its forward limit. In one example this spring comprises a coil torsion spring 316 operably connected between the first link 304 and fourth link 310. In one example this spring comprises an axial coil spring 718 operably connected between first link 722 and second link 724 via a linkage arm 716, such as depicted in FIG. 7.

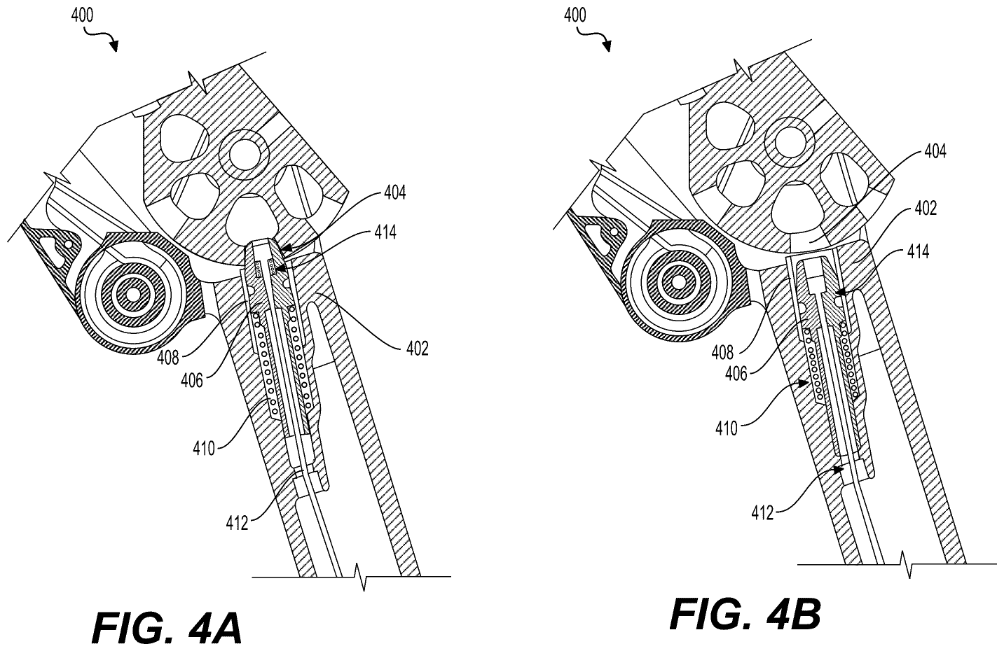

In some examples, the detent latch 314 may include an assembly or configuration as illustrated in FIGS. 4A-4B. FIGS. 4A-4B illustrate a detail view 400 of a latch portion of the positionable seat assembly. In the detail view 400 the latch 314 may take the form of a detent latch 406 that rides in a tube inside the first link 402. The detent latch 406 may be operably connected to a spring 410 such that it engages with the detent features 404 when no external loads are applied to the detent latch 406, thus locking out the linkage as depicted in FIG. 4A. An actuation cable 412 may be operably connected to the detent latch 406 such that it can pull the pin away from the detent features thereby allowing the linkage to move freely, such as depicted in FIG. 4B. An additional spring 414 may be operably connected between the locking pin and cable to maintain cable tension when the locking pin is engaged with a detent feature.

The latch 406, or other latches that may be implemented with the positionable seat assembly, may be actuated via a switch or lever mounted to one or more of the links. In one example the detent latch 406 may be actuated via a cable 412 operably connected to a trigger that may be placed on the vehicle (for example at the handlebars) and actuated by a rider during use, the trigger being operably coupled to the cable 412 to cause actuation of the latch 406. In an example, the cable 412 may include a Bowden cable or other flexible cable or assembly that may be used to transmit mechanical force or energy. For example, a Bowden cable may include an inner cable 326 that moves relative to a hollow outer housing 328 and linear movement of the inner cable may be used to transmit a mechanical force to the latch 406.

In some examples the detent latch 406 may be actuated via a hydraulic circuit operably coupled with a remote trigger that can be placed elsewhere on the vehicle. In one example the detent latch 406 may be actuated via an electrical motive source such as a solenoid, motor driven gear train, or other such system that is operably connected to a remote trigger that can be placed elsewhere on the vehicle. In one example the connection between the latch 406 and remote trigger may depart from the latch 406 at the first link 402 and be routed through the seat post and further be routed to the trigger at least in part through the inside of the frame of the vehicle. In one example the connection between the latch and remote trigger may also be outside the seat post and be routed to the trigger along the outside of the frame.

In some examples the detent latch 406 may be directly coupled with the means of actuation. In some examples the means of actuation may be coupled to a release element that engages with the detent latch 406 for only part of its stroke. In some examples the release element may be operably connected to a release spring 414 which maintains tension in the cable when the latch is engaged. In some examples the release spring is connected between the release element and detent latch 406. In some examples the release element is connected between the release element and the first link 402.

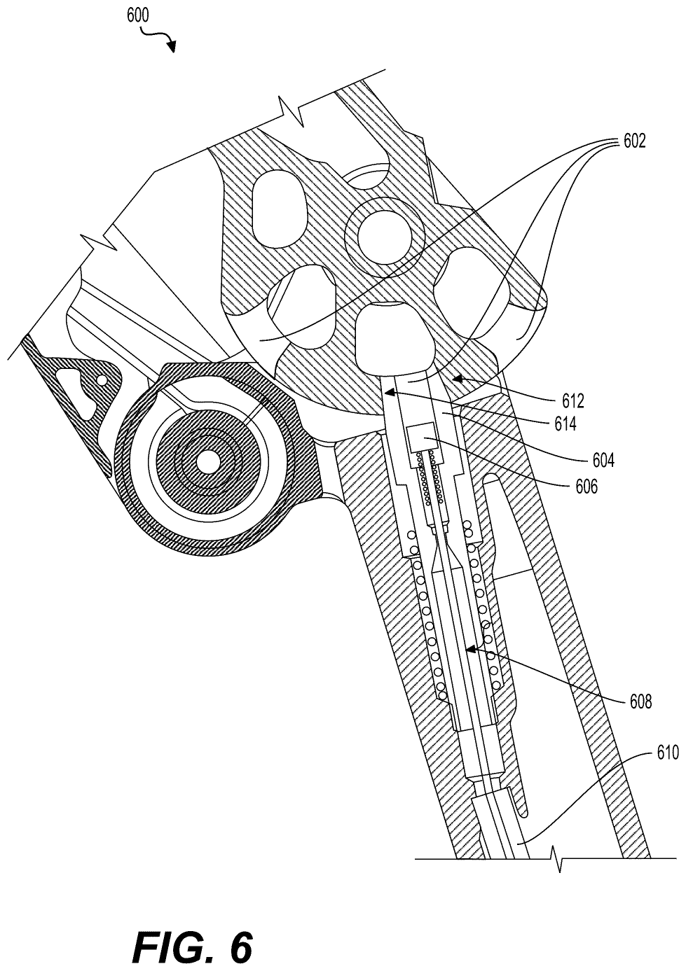

FIG. 6 depicts a detail view of a portion of a positionable seat assembly 600, according to at least one example. The positionable seat assembly 600 includes elements as described herein such as detents 602, detent latch 604, latch release 606, cable 608, and Bowden cable 610. In some examples, such as depicted in FIG. 6, the detent latch 604 may be made asymmetrical such that a first face 612 which restricts forward movement of the linkage is angled differently than a second face 614 which restricts rearward movement enabling each angle to be optimized independently.

FIG. 7 depicts a positionable seat assembly 700 with a pawl-style latch, according to at least one example. The positionable seat assembly 700 includes link 702, 704, 706, seat 720. The pawl 712 is operably connected to a first link 702 by a pivot and biased into position by a spring element 714. The detent latch engages with detents 708 as the first link 702 rotates. In some examples the detent latch and detent features may take the form of a star ratchet ring with multiple engagement points.

As depicted in FIG. 7, the first link 702 may be biased using a spring element 718 that rests within the seat tube and connects at element 716, though other configurations such as Bowden cables, hydraulics, solenoids, and other such mechanisms may be used to apply force to the first link 702. The pawl 712 may be released by rotating the pawl 712 such as due to a motion of a Bowden cable, hydraulic circuit, solenoid or other such element to trigger the latch.

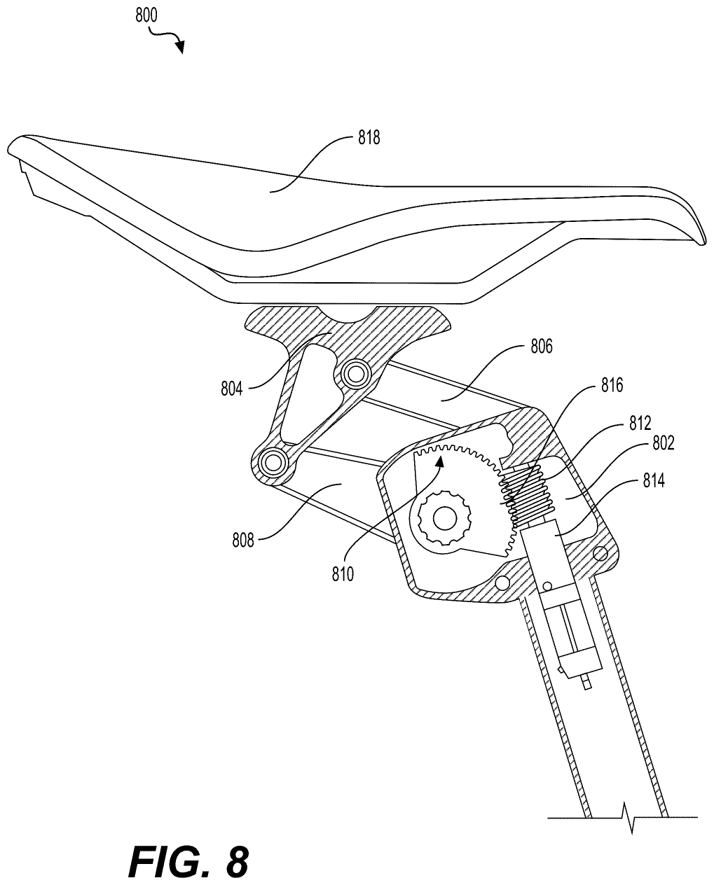

FIG. 8 depicts a positionable seat assembly 800 with a gearbox for movement of the linkages, according to at least one example. The positionable seat assembly 800 may include elements as described above including links 802, 804, 806, and 808 as well as seat 818.

In some examples movement between two or more of the links may be restricted via a gearbox 816 and electric motor 814. In one example this gearbox 816 is designed such that it may not be possible to backdrive or counter-rotate, and will only move when driven by the electric motor 814 that is powered and controlled by a power and control circuit that may be situated inside the seat tube or on the frame of the vehicle and actuated by a switch at the handlebars. In one example there is a separate locking mechanism that restricts movement in the gearbox 816 such that the system can hold a load when unpowered. In one example this gearbox includes a worm gear 812, operably connected to one link 802 and engaged with a worm wheel 810 operably connected to an adjacent link 804.

In one example there may be a position sensor which can detect the position of one or more of the linkages relative to one another. The position sensor may be used to convey position data to a circuit board or controller that may be used to operate the positionable seat assembly.

In one example the electric motor can drive the gearbox, and thus the linkage to two or more pre-programmed positions via a closed loop control with a position sensor. In one example a load sensor is operably connected to the linkage such that force applied to the saddle by the rider can be measured. In one example the load measurement may be used to delay triggered movement until the rider has unweighted the saddle sufficiently for the motor to drive the system smoothly. In one example the movement of the linkage may be controlled by one or more electric buttons on the system itself. In one example movement of the saddle may be controlled by a remote controller mounted elsewhere on the bicycle. In one example this remote controller may be connected electrically to the motor system via wires. In one example this remote controller may be connected to the motor system via a radio signal. In one example this controller may have multiple buttons enabling the rider to initiate incremental or continuous movements in either direction. In one example this controller may have a single button that cycles through pre-programed positions incrementally or continuously. In one example this controller may have a single button that primes the system to move incrementally or continuously, with the direction of movement determined by load applied to the linkage via the saddle as read by the load sensor.

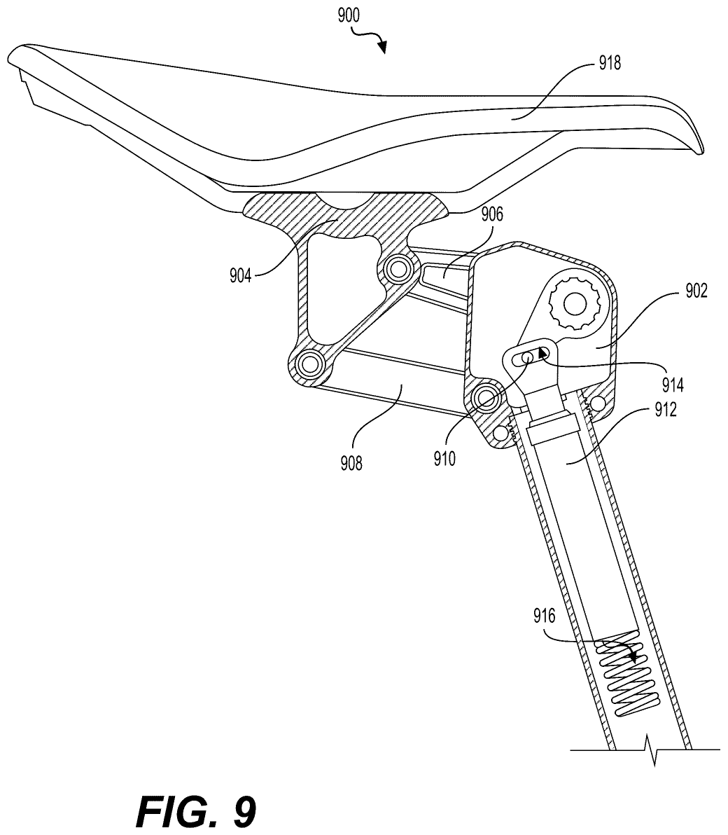

In one example, such as depicted in FIGS. 9-11, the positionable seat assembly 900 may include links 902, 904, 906, and 908 and also includes a linear member 912 operably connected between two links (e.g., between link 902 and 906). The positionable seat assembly 900 includes the seat 918 for the bicycle. The actuation of the linear member 912 may cause rotation of the pivot that couples the link 902 and the link 906 to cause repositioning of the positionable seat assembly 900.

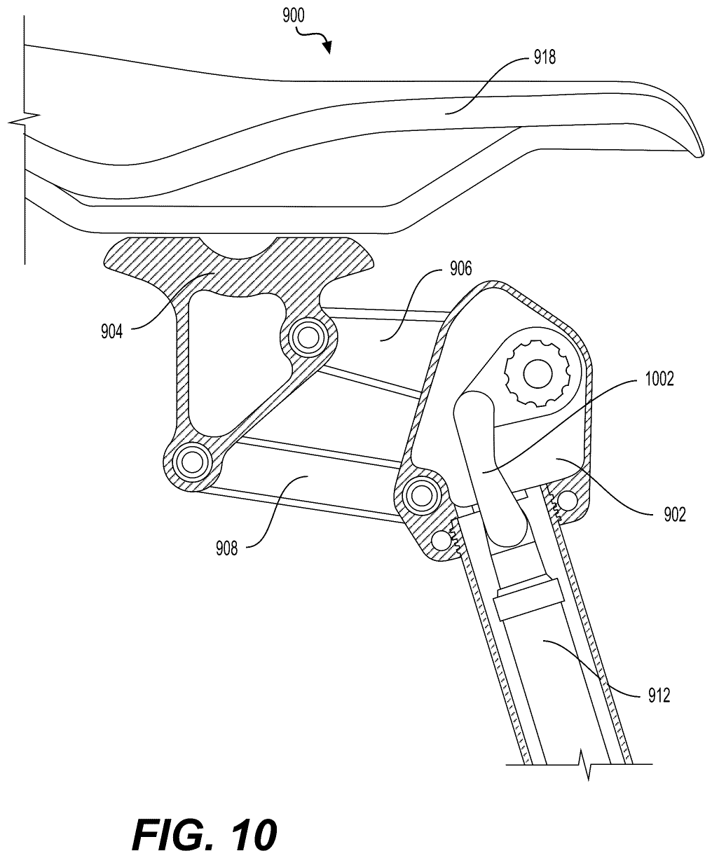

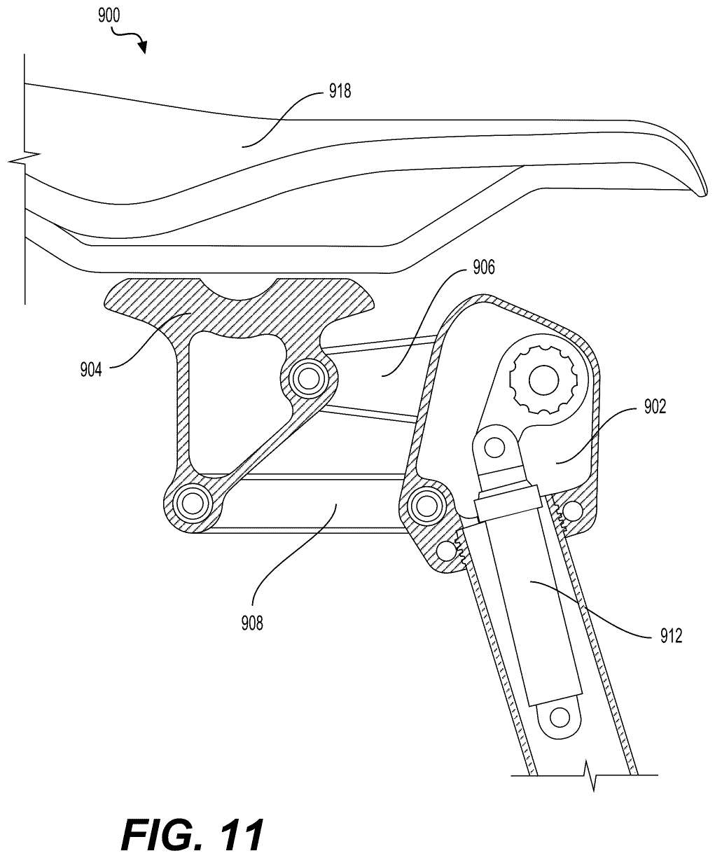

In some examples movement of the linkage is restricted or induced by a linear member such as a hydraulic piston, nut and screw or axial spring. In one example of the positionable seat assembly 900 said linear system is fixed relative to one link 902 and engages with the adjacent link via a slot 914 in which a roller or slider of pin 910 moves. In one example, such as shown in FIG. 10, the linear member 912 is fixed to one link 902 and engages with the adjacent link 906 via an additional link 1002. In one example, such as depicted in FIG. 11, the linear member 912 may be operably connected to two adjacent links 902 and 906 via a pivot on each end.

The linear member may include a worm gear, lead screw, ball screw, hydraulic piston, air piston, solenoid, or other component configured to move linearly and cause rotation of the linkages relative to one another through rotation of the pivot between the linkages as a result of the linear member 912 being connected to a lever arm to apply a torque to the pivot between the linkages.

The linear member may include a slot 914 with a pin 910 to enable movement of the lever arm around an arc when the linear member 912 is actuated. As depicted in FIG. 10, the linear member 912 may couple to the lever arm through a link 1002.

In one example the movement between two or more links may be restricted via a hydraulic lockout operably connected between two links. In one example this hydraulic lockout comprises a linear piston as part of the linear member 912.

In some examples movement of the linkage is restricted or induced by a linear member such as a hydraulic piston, nut and screw or axial spring. In one example of the positionable seat assembly 900 said linear system is fixed relative to one link 902 and engages with the adjacent link via a slot 914 in which a roller or slider of pin 910 moves. In one example, such as shown in FIG. 10, the linear member 912 is fixed to one link 902 and engages with the adjacent link 906 via an additional link 1002. In one example, such as depicted in FIG. 11, the linear member 912 may be operably connected to two adjacent links 902 and 906 via a pivot on each end.

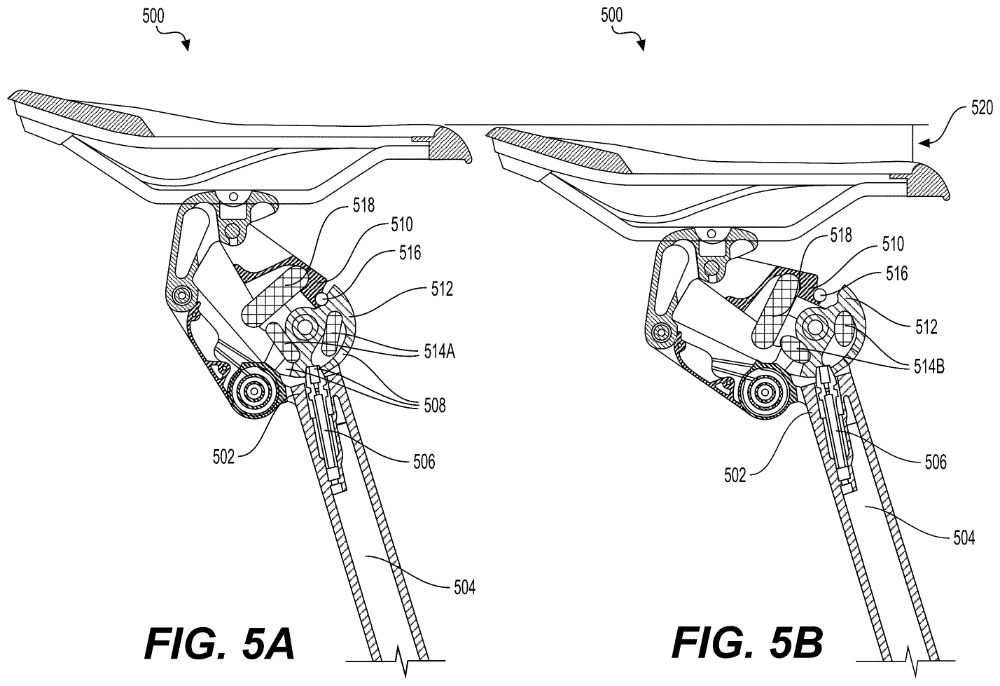

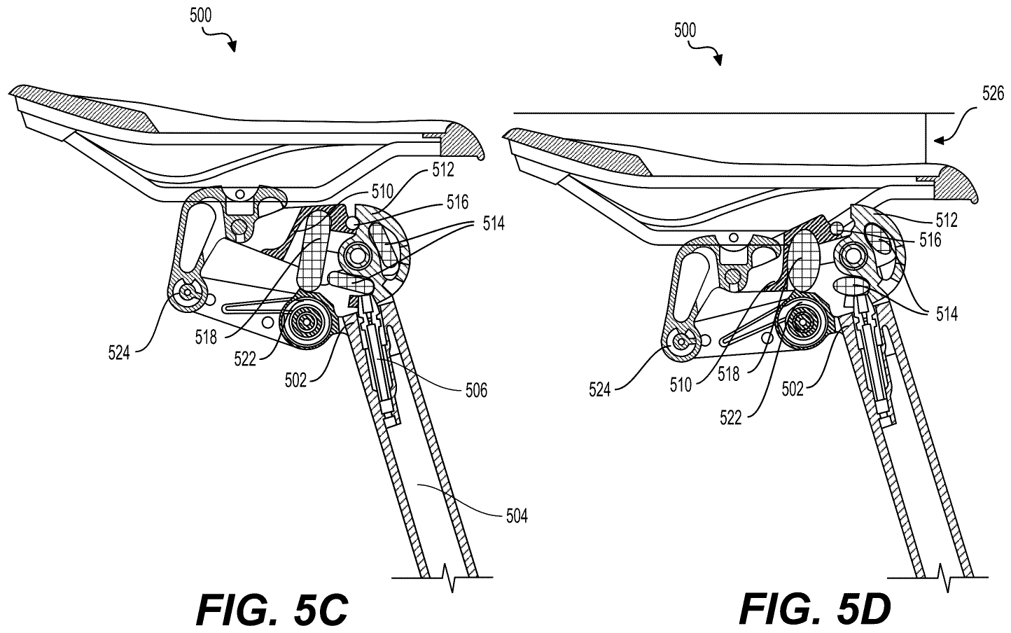

The positionable seat assembly 900 may include a suspension element 916, such as a mechanical spring, air spring, elastomer or other elastic or energy absorbing material capable of providing suspension to the positionable seat assembly 900, either inline with the linear member, as depicted in FIGS. 9-11 or built-in to the positionable seat assembly 500, as depicted in FIGS. 5A-5D. Said elastic member providing a suspension effect along the same path defined by the linkage is achieved when the saddle is loaded.

FIGS. 5A-5D depict a positionable seat assembly 500, according to at least one example. The positionable seat assembly 500 may include a locking mechanism that is rigidly coupled with its associated links. In some examples the positionable seat assembly 500 may further comprise a suspension mechanism in series with the locking mechanism. The positionable seat assembly 500 includes a seat post 504, a first link 502, a latch 506, detents 508, link 510, and other such components as described above with respect to positionable seat assemblies of FIGS. 1-4. The positionable seat assembly 500 may enable the seat to move a vertical distance 520 between the positions shown in FIGS. 5A and 5B and further a vertical distance 526 between the positions shown in FIGS. 5C and 5D.

In one example, the detent features may be part of a separate component 512 which is rotationally coupled with its link 510 around the same axis which connects the second link 510 to the first link 502 which contains the latch 506. In this example the detent features and second link may be elastically coupled such that a suspension effect along the same path defined by the linkage is achieved when the saddle is loaded. In an example the elastic coupling may include one or more elastomer inserts 514 which shift the saddle forward when unloaded 514A and allow the saddle to compress down and back when loaded 514B. A top out bumper 516 may limit the movement, in the forward direction, of the components forming the link 510 that includes the elastomer inserts 514. In one example the suspension effect may occur regardless of where in the stroke the linkage is set. In one example an additional elastic element 518 may be included that is unengaged when the saddle is in one or more position settings and engages when the linkage is at a lowest setting. Such an example increases the stiffness of the suspension to compensate for the increased leverage caused by having the linkage in a lower position. In one example a hard stop may be introduced when the linkage is at one or the other extreme to lock out said suspension effect.

In some examples a spring 522 may be operably connected between two of the links such that the movement of the seat position when the latch 506 is released may be biased in a first or second direction. For example, the spring 522 may include an axial spring that biases the seat upwards such that when the latch 506 is released the seat returns to an upright position and is moved to a lower position by pressure applied by the weight of the rider.

In some examples a damper 524 may be operably connected between two of the links such that movement speed is limited when changing positions. In one example this damper 524 may take the form of a rotary vane dash pot integrated into the pivot between two links. In one example this damper may be integrated into a linear member that restricts or induces movement in the adjustable seat assembly. In one example this damper may provide a damping effect to any elastic suspension the linkage provides. In one example the damper may be tuned to exhibit a stronger damping force in one direction than in the other.

Spatially relative terms, such as “top,” “bottom,” “front,” “back,” “upper,” “lower,” etc., is used with reference to the orientation of the Figure(s) being described. Because components of examples can be positioned in a number of different orientations, the directional terminology is used for purposes of illustration and is in no way limiting. It is to be understood that other examples may be utilized and structural or logical changes may be made without departing from the scope of the present invention. The following detailed description, therefore, is not to be taken in a limiting sense, and the scope of the present invention is defined by the appended claims.

As used herein, the terms “having,” “containing,” “including,” “comprising” and the like are open-ended terms that indicate the presence of stated elements or features, but do not preclude additional elements or features. The articles “a,” “an” and “the” are intended to include the plural as well as the singular, unless the context clearly indicates otherwise.

Notably, modifications and other examples of the disclosed invention(s) will come to mind to one skilled in the art having the benefit of the teachings presented in the foregoing descriptions and the associated drawings. Therefore, it is to be understood that the invention(s) is/are not to be limited to the specific examples disclosed and that modifications and other examples are intended to be included within the scope of this disclosure. Although specific terms may be employed herein, they are used in a generic and descriptive sense only and not for purposes of limitation.

### EXAMPLE CLAUSES

While the example clauses described above are described with respect to one particular implementation, it should be understood that, in the context of this document, the content of the example clauses can also be implemented via a method, device, system, computer-readable medium, and/or another implementation. Additionally, any of examples A-T may be implemented alone or in combination with any other one or more of the examples A-T.

A: A positionable seat assembly for a bicycle configured to enable a seat to be moved between two or more fixed positions, the positionable seat assembly coupled between a seat and a seat post and comprising: a first link fixedly coupled with the seat post; a second link rotatably coupled with the first link at a first pivot; a third link fixedly coupled with the seat and rotatably coupled with the second link at a second pivot; and a fourth link rotatably coupled to the first link at a third pivot and to the third link at a fourth pivot; and a locking mechanism comprising: two or more detents arranged radially about the first pivot; and a latch member configured to engage with the two or more detents to enable the positionable seat assembly to be configured in a first position and a second position, wherein: in the first position the seat is at a first height and a first horizontal position; and in the second position the seat is at a second height less than the first height and a second horizontal position positioned rearward of the first horizontal position.

B: The positionable seat assembly of claim A, wherein the latch member is actuated by a control routed through a frame of the bicycle and positioned at handlebars of the bicycle.

C: The positionable seat assembly of claim B, wherein the latch member is actuated by a Bowden cable.

D: The positionable seat assembly of claim A, wherein at least one of the first pivot, second pivot, third pivot, or fourth pivot comprise a spring configured to bias the positionable seat assembly towards the first position.

E: The positionable seat assembly of claim D, wherein the spring comprises a torsion spring positioned at a pivot location between adjacent links.

F: The positionable seat assembly of claim A, wherein at least one of the first pivot, second pivot, third pivot, or fourth pivot comprise a damping mechanism.

G: The positionable seat assembly of claim A, further comprising one or more elastic elements coupled between the locking mechanism and one of its associate links and configured to provide a suspension element for a bike seat.

H: A seat adjustment assembly comprising: a first link fixedly coupled with a seat post; a second link rotatably coupled with the first link at a first pivot; a third link fixedly coupled with a seat and rotatably coupled with the second link at a second pivot; and a fourth link rotatably coupled to the first link at a third pivot and to the third link at a fourth pivot; and a positioning mechanism comprising: a drive element configured to drive a rotating element; and an interface component coupled with the second link or the fourth link that interfaces with the drive element to change a position of the second link or the fourth link when the drive element is engaged, wherein the drive element is controllable by a control device of a bicycle to enable the seat adjustment assembly to be configured in a first position and a second position, wherein: in the first position the seat is at a first height and a first horizontal position; and in the second position the seat is at a second height less than the first height and a second horizontal position positioned rearward of the first horizontal position.

I: The seat adjustment assembly of claim H, wherein: the drive element comprises a motor and a worm gear; and the interface component comprises a gear driven by the worm gear.

J: The seat adjustment assembly of claim H, wherein the motor: is electrically coupled with a power source connected to a frame of the bicycle; and is controllable in a first direction or a second direction by a control positioned at a handlebar of the bicycle.

K: The seat adjustment assembly of claim H, wherein: the drive element comprises a first gear configured to be driven about a first axis parallel with an axis of a seat tube of the bicycle; and the interface element comprises a second gear configured to be driven about a second axis perpendicular to the first axis.

L: The seat adjustment assembly of claim H, wherein the drive element and interface component are contained within a gearbox coupled to the first link at one of the first pivot or the third pivot, the gearbox configured to drive a rotational position of the first link and at least one of the second link or the fourth link.

M: The seat adjustment assembly of claim L, further comprising an elastic element situated between the gearbox and one of the first link, second link, or fourth link and configured to provide a suspension element for a bicycle seat.

N: The seat adjustment assembly of claim H, further comprising: a position sensor configured to detect a position of the seat adjustment assembly; and a controller configured to drive the drive element in response to a user input and data from the position sensor.

O: The seat adjustment assembly of claim H, wherein in the first position the seat is oriented at a first angle and in the second position the seat is oriented at a second angle, the second angle within a threshold amount of the first angle.

P: A positionable seat post assembly for a bicycle comprising: a first link fixedly coupled with the seat post; a second link rotatably coupled with the first link at a first pivot; a third link fixedly coupled with the seat and rotatably coupled with the second link at a second pivot; and a fourth link rotatably coupled to the first link at a third pivot and to the third link at a fourth pivot; and a linear mechanism comprising: a linear member driven along a first axis substantially parallel with the seat post; and a lever that engages with a distal end of the linear member, the lever coupled with the second link or the fourth link and configured to cause movement of the second link or the fourth link when force is applied to the lever between a first position and a second position, wherein: in the first position the seat is at a first height and a first horizontal position; and in the second position the seat is at a second height less than the first height and a second horizontal position positioned rearward of the first horizontal position.

Q: The positionable seat post assembly of claim P, wherein the linear member comprises a hydraulic member that drives along the first axis in response to a control signal.

R: The positionable seat post assembly of claim P, wherein the linear member defines a slot at the distal end of the linear member and the lever comprises a roller bearing configured to ride within the slot.

S: The positionable seat post assembly of claim P, wherein the linear member comprises at least of an air cylinder, hydraulic cylinder, eletromechanical linear actuator, or other linear mechanism.

T: The positionable seat post assembly of claim P, further comprising one or more spring elements arranged in series with the linear member and configured to provide a suspension element for a bike seat.

What is claimed is:

1. A positionable seat assembly for a bicycle configured to enable a seat to be moved between two or more fixed positions, the positionable seat assembly coupled between a seat and a seat post and comprising:
a first link fixedly coupled with the seat post;
a second link rotatably coupled with the first link at a first pivot;
a third link fixedly coupled with the seat and rotatably coupled with the second link at a second pivot; and
a fourth link rotatably coupled to the first link at a third pivot and to the third link at a fourth pivot; and
a locking mechanism comprising:
two or more detents arranged radially about the first pivot; and
a latch member configured to engage with the two or more detents to enable the positionable seat assembly to be configured in a first position and a second position, wherein:
in the first position the seat is at a first height and a first horizontal position; and
in the second position the seat is at a second height less than the first height and a second horizontal position positioned rearward of the first horizontal position.

2. The positionable seat assembly of claim 1, wherein the latch member is actuated by a control routed through a frame of the bicycle and positioned at handlebars of the bicycle.

3. The positionable seat assembly of claim 2, wherein the latch member is actuated by a Bowden cable.

4. The positionable seat assembly of claim 1, wherein at least one of the first pivot, second pivot, third pivot, or fourth pivot comprise a spring configured to bias the positionable seat assembly towards the first position.

5. The positionable seat assembly of claim 4, wherein the spring comprises a torsion spring positioned at a pivot location between adjacent links.

6. The positionable seat assembly of claim 1, wherein at least one of the first pivot, second pivot, third pivot, or fourth pivot comprise a damping mechanism.

7. The positionable seat assembly of claim 1, further comprising one or more elastic elements coupled between the locking mechanism and one of its associate links and configured to provide a suspension element for a bike seat.

8. A seat adjustment assembly comprising:
a first link fixedly coupled with a seat post;
a second link rotatably coupled with the first link at a first pivot;
a third link fixedly coupled with a seat and rotatably coupled with the second link at a second pivot; and
a fourth link rotatably coupled to the first link at a third pivot and to the third link at a fourth pivot; and
a positioning mechanism comprising:
a drive element configured to drive a rotating element; and
an interface component coupled with the second link or the fourth link that interfaces with the drive element to change a position of the second link or the fourth link when the drive element is engaged, wherein the drive element is controllable by a control device of a bicycle to enable the seat adjustment assembly to be configured in a first position and a second position, wherein:
in the first position the seat is at a first height and a first horizontal position; and
in the second position the seat is at a second height less than the first height and a second horizontal position positioned rearward of the first horizontal position.

9. The seat adjustment assembly of claim 8, wherein:
the drive element comprises a motor and a worm gear; and
the interface component comprises a gear driven by the worm gear.

10. The seat adjustment assembly of claim 8, wherein the motor:
is electrically coupled with a power source connected to a frame of the bicycle; and
is controllable in a first direction or a second direction by a control positioned at a handlebar of the bicycle.

11. The seat adjustment assembly of claim 8, wherein:
the drive element comprises a first gear configured to be driven about a first axis parallel with an axis of a seat tube of the bicycle; and
the interface element comprises a second gear configured to be driven about a second axis perpendicular to the first axis.

12. The seat adjustment assembly of claim 8, wherein the drive element and interface component are contained within a gearbox coupled to the first link at one of the first pivot or the third pivot, the gearbox configured to drive a rotational position of the first link and at least one of the second link or the fourth link.

13. The seat adjustment assembly of claim 8, wherein the drive element and the interface element comprise a gearbox configured to receive a rotational input at a first side about a first axis parallel with a seat tube and output a rotational input at a second side about a second axis perpendicular with the first axis.

14. The seat adjustment assembly of claim 8, further comprising:
a position sensor configured to detect a position of the seat adjustment assembly; and
a controller configured to drive the drive element in response to a user input and data from the position sensor.

15. The seat adjustment assembly of claim 8, wherein in the first position the seat is oriented at a first angle and in the second position the seat is oriented at a second angle, the second angle within a threshold amount of the first angle.

16. A positionable seat post assembly for a bicycle comprising:
a first link fixedly coupled with the seat post;
a second link rotatably coupled with the first link at a first pivot;
a third link fixedly coupled with the seat and rotatably coupled with the second link at a second pivot; and
a fourth link rotatably coupled to the first link at a third pivot and to the third link at a fourth pivot; and
a linear mechanism comprising:
a linear member driven along a first axis substantially parallel with the seat post; and
a lever that engages with a distal end of the linear member, the lever coupled with the second link or the fourth link and configured to cause movement of the second link or the fourth link when force is applied to the lever between a first position and a second position, wherein:
in the first position the seat is at a first height and a first horizontal position; and
in the second position the seat is at a second height less than the first height and a second horizontal position positioned rearward of the first horizontal position.

17. The positionable seat post assembly of claim 16, wherein the linear member comprises a hydraulic member that drives along the first axis in response to a control signal.

18. The positionable seat post assembly of claim 16, wherein the linear member defines a slot at the distal end of the linear member and the lever comprises a roller bearing configured to ride within the slot.

19. The positionable seat post assembly of claim 16, wherein the linear member comprises at least of an air cylinder, hydraulic cylinder, eletromechanical linear actuator, or other linear mechanism.

20. The positionable seat post assembly of claim 16, further comprising one or more spring elements arranged in series with the linear member and configured to provide a suspension element for a bike seat.
